(19) United States
(12) Patent Application Publication
(10) Pub. No.: US 2014/0265035 A1
(43) Pub. Date: Sep. 18, 2014

(54) THREE-DIMENSIONAL PRINTING WITH CONTROL OF THERMOALTERABLE BUILD MATERIALS

(71) Applicant: MakerBot Industries, LLC, Brooklyn, NY (US)

(72) Inventors: Anthony James Buser, Reading, PA (US); Christine Jan Lawrence Sumerel, Brecksville, OH (US)

(73) Assignee: MakerBot Industries, LLC, Brooklyn, NY (US)

(21) Appl. No.: 14/209,372

(22) Filed: Mar. 13, 2014

Related U.S. Application Data
(60) Provisional application No. 61/780,332, filed on Mar. 13, 2013.

(51) Int. Cl. B29C 67/00

(52) U.S. Cl. CPC B29C 67/0088; B29C 67/0055
USPC 264/401; 425/143

(57) ABSTRACT

A variety of thermoalterable build materials are disclosed for use in three-dimensional printing, along with techniques for controlling properties of such materials in a fabricated object. In particular, changes in material flow rate permit instantaneous changes in heat transfer and resulting variations in the amount of thermoalteration, without requiring any changes to the temperature of a heater or extruder used to extrude the material. In this manner, flow rate facilitates spatial control of properties within a fabricated object.

### RELATED APPLICATIONS

This application claims the benefit of U.S. Provisional Application No. 61/780,332 filed on Mar. 13, 2013, the entire content of which is hereby incorporated by reference.

This application is also related to U.S. application Ser. No. 13/691,460 filed on Nov. 30, 2012, and U.S. App. No. 61/642,745 filed on May 4, 2012, the entire contents of which are hereby incorporated by reference.

### BACKGROUND

There remains a need for improved techniques to spatially control the properties of an object fabricated with a three-dimensional printer.

### SUMMARY

A variety of thermoalterable build materials are disclosed for use in three-dimensional printing, along with techniques for controlling properties of such materials in a fabricated object. In particular, changes in material flow rate permit instantaneous changes in heat transfer and resulting variations in the amount of thermoalteration, without requiring any changes to the temperature of a heater or extruder used to extrude the material. In this manner, flow rate facilitates spatial control of properties within a fabricated object.

In one aspect, a three-dimensional printer includes a memory storing a model of an object and a map of variations in at least one property that spatially varies within the object, a supply of a thermoalterable build material including a composition that exhibits a continuous, irreversible change in the property in response to an applied thermal energy and a reversible viscosity change in response to the applied thermal energy, an x-y-z positioning assembly, and an extruder coupled to the x-y-z positioning assembly, where the extruder includes a heating element configured to heat the thermoalterable build material, thereby providing a heated build material. The three-dimensional printer may also include a controller coupled to the x-y-z positioning assembly and the extruder, where the controller is programmed to heat the thermoalterable build material with the heater to a first temperature suitable for extrusion. The controller may be further programmed to operate the x-y-z positioning assembly while extruding the thermoalterable build material to fabricate the object, where the controller alters a flow rate of the thermoalterable build material through the extruder to cause a change in heat transfer to the thermoalterable build material so that the property of the thermoalterable build material is controlled within the object according to the map.

In another aspect, a method for three-dimensional printing includes: providing a model of an object and a map of variations in at least one property that spatially varies within the object; providing a supply of a thermoalterable build material including a composition that exhibits a continuous, irreversible change in the property in response to an applied thermal energy and a reversible viscosity change in response to the applied thermal energy; liquefying the thermoalterable build material at a predetermined temperature to obtain the reversible change in viscosity; extruding the thermoalterable build material in a predetermined pattern according to the model; and varying a flow rate of the thermoalterable build material according to the map thereby producing the object with variations in the property according to the map.

In yet another aspect, a computer program product for building an object from a supply of a thermoalterable build material including a composition that exhibits a continuous, irreversible change in the at least one property in response to an applied thermal energy and a reversible viscosity change in response to the applied thermal energy includes computer executable code embodied in a non-transitory computer readable medium that, when executing on a three-dimensional printer, performs the steps of: receiving a model of an object and a map of variations in the property that spatially varies within the object; liquefying the thermoalterable build material at a predetermined temperature to obtain the reversible change in viscosity; extruding the thermoalterable build material in a predetermined pattern according to the model; and varying a flow rate of the thermoalterable build material according to the map thereby producing the object with variations in the at least one property according to the map.

### BRIEF DESCRIPTION OF THE FIGURES

The foregoing and other objects, features, and advantages of the devices, systems, and methods described herein will be apparent from the following description of particular embodiments thereof, as illustrated in the accompanying figures, where like references numbers refer to like structures. The figures are not necessarily to scale, emphasis instead being placed upon illustrating the principles of the devices, systems, and methods described herein.

FIG. 1 is a block diagram of a three-dimensional printer.

FIG. 2 shows a map of material properties for use in fabricating a three-dimensional object.

FIG. 3 shows a cross section of a polymer-thermochromic composite build material.

FIG. 4 shows a method for three-dimensional printing using a thermoalterable build material.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “above,” “below,” and the like, are words of convenience and are not to be construed as limiting terms.

The following description emphasizes three-dimensional printers using fused deposition modeling or similar techniques where a bead of material is extruded in a layered series of two dimensional patterns as “roads,” “paths,” or the like to form a three-dimensional object from a digital model. It will be understood, however, that numerous additive fabrication techniques are known in the art including without limitation multijet printing, stereolithography, Digital Light Processor (“DLP”) three-dimensional printing, selective laser sintering, and so forth. Such techniques may benefit from the systems and methods described below, and all such printing technologies are intended to fall within the scope of this disclosure, and within the scope of terms such as “printer,” “three-dimensional printer,” “fabrication system,” and so forth, unless a more specific meaning is explicitly provided or otherwise clear from the context.

FIG. 1 is a block diagram of a three-dimensional printer. In general, the printer 100 may include a build platform 102, an extruder 106, an x-y-z positioning assembly 108, and a controller 110 that cooperate to fabricate an object 112 within a working volume 114 of the printer 100.

The build platform 102 may include a surface 116 that is rigid and substantially planar. The surface 116 may provide a fixed, dimensionally and positionally stable platform on which to build the object 112. The build platform 102 may include a thermal element 130 that controls the temperature of the build platform 102 through one or more active devices 132, such as resistive elements that convert electrical current into heat, Peltier effect devices that can create a heating or cooling affect, or any other thermoelectric heating and/or cooling devices. The thermal element 130 may be coupled in a communicating relationship with the controller 110 in order for the controller 110 to controllably impart heat to or remove heat from the surface 116 of the build platform 102.

The extruder 106 may include a chamber 122 in an interior thereof to receive a build material. The build material may, for example, include acrylonitrile butadiene styrene (“ABS”), high-density polyethylene (“HDPL”), polylactic acid (“PLA”), or any other suitable plastic, thermoplastic, or other material that can usefully be extruded to form a three-dimensional object. The extruder 106 may include an extrusion tip 124 or other opening that includes an exit port with a circular, oval, slotted or other cross-sectional profile that extrudes build material in a desired cross-sectional shape.

The extruder 106 may include a heater 126 (also referred to as a heating element) to melt thermoplastic or other meltable build materials within the chamber 122 for extrusion through an extrusion tip 124 in liquid form. While illustrated in block form, it will be understood that the heater 126 may include, e.g., coils of resistive wire wrapped about the extruder 106, one or more heating blocks with resistive elements to heat the extruder 106 with applied current, an inductive heater, or any other arrangement of heating elements suitable for creating heat within the chamber 122 sufficient to melt the build material for extrusion. The extruder 106 may also or instead include a motor 128 or the like to push the build material into the chamber 122 and/or through the extrusion tip 124. The motor 128 may be a filament drive configured to propel a filament of build material through the extruder 106 at a variable rate. The motor 128 may be controllable, e.g., to control a flow rate or deposition rate of the build material.

In general operation (and by way of example rather than limitation), a build material such as ABS plastic in filament form may be fed into the chamber 122 from a spool or the like by the motor 128, melted by the heater 126, and extruded from the extrusion tip 124. By controlling a rate of the motor 128, the temperature of the heater 126, and/or other process parameters, the build material may be extruded at a controlled volumetric rate and/or temperature. It will be understood that a variety of techniques may also or instead be employed to deliver build material at a controlled volumetric rate, which may depend upon the type of build material, the volumetric rate desired, and any other factors. All such techniques that might be suitably adapted to delivery of build material for fabrication of a three-dimensional object are intended to fall within the scope of this disclosure.

The x-y-z positioning assembly 108 may generally be adapted to three-dimensionally position the extruder 106 and the extrusion tip 124 within the working volume 114. Thus, by controlling the volumetric rate of delivery for the build material and the x, y, z position of the extrusion tip 124, the object 112 may be fabricated in three dimensions by depositing successive layers of material in two-dimensional patterns derived, for example, from cross-sections of a computer model or other computerized representation of the object 112. A variety of arrangements and techniques are known in the art to achieve controlled linear movement along one or more axes. The x-y-z positioning assembly 108 may, for example, include a number of stepper motors 109 to independently control a position of the extruder 106 within the working volume along each of an x-axis, a y-axis, and a z-axis. More generally, the x-y-z positioning assembly 108 may include without limitation various combinations of stepper motors, encoded DC motors, gears, belts, pulleys, worm gears, threads, and so forth. For example, in one aspect, the build platform 102 may be coupled to one or more threaded rods by a threaded nut so that the threaded rods can be rotated to provide z-axis positioning of the build platform 102 relative to the extruder 106. This arrangement may advantageously simplify design and improve accuracy by permitting an x-y positioning mechanism for the extruder 106 to be fixed relative to a build volume. Any such arrangement suitable for controllably positioning the extruder 106 within the working volume 114 may be adapted to use with the printer 100 described herein.

In general, this may include moving the extruder 106, or moving the build platform 102, or some combination of these. Thus, it will be appreciated that any reference to moving an extruder relative to a build platform, working volume, or object, is intended to include movement of the extruder or movement of the build platform, or both, unless a more specific meaning is explicitly provided or otherwise clear from the context. Still more generally, while an x, y, z coordinate system serves as a convenient basis for positioning within three dimensions, any other coordinate system or combination of coordinate systems may also or instead be employed, such as a positional controller and assembly that operates according to cylindrical or spherical coordinates.

The controller 110 may be electrically or otherwise coupled in a communicating relationship with the build platform 102, the x-y-z positioning assembly 108, and the other various components of the printer 100. In general, the controller 110 is operable to control the components of the printer 100, such as the build platform 102, the x-y-z positioning assembly 108, and any other components of the printer 100 described herein to fabricate the object 112 from the build material. The controller 110 may include any combination of software and/or processing circuitry suitable for controlling the various components of the printer 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. In one aspect, this may include circuitry directly and physically associated with the printer 100 such as an on-board processor. In another aspect, this may be a processor associated with a personal computer or other computing device coupled to the printer 100, e.g., through a wired or wireless connection. Similarly, various functions described herein may be allocated between an on-board processor for the printer 100 and a separate computer. All such computing devices and environments are intended to fall within the meaning of the term “controller” or “processor” as used herein, unless a different meaning is explicitly provided or otherwise clear from the context.

A variety of additional sensors and other components may be usefully incorporated into the printer 100 described above. These other components are generically depicted as other hardware 134 in FIG. 1, for which the positioning and mechanical/electrical interconnections with other elements of the printer 100 will be readily understood and appreciated by one of ordinary skill in the art. The other hardware 134 may include a temperature sensor positioned to sense a temperature of the surface of the build platform 102, the extruder 106, or any other system components. This may, for example, include a thermistor or the like embedded within or attached below the surface of the build platform 102. This may also or instead include an infrared detector or the like directed at the surface 116 of the build platform 102.

In another aspect, the other hardware 134 may include a sensor to detect a presence of the object 112 at a predetermined location. This may include an optical detector arranged in a beam-breaking configuration to sense the presence of the object 112 at a predetermined location. This may also or instead include an imaging device and image processing circuitry to capture an image of the working volume and to analyze the image to evaluate a position of the object 112. This sensor may be used for example to ensure that the object 112 is removed from the build platform 102 prior to beginning a new build on the working surface 116. Thus, the sensor may be used to determine whether an object is present that should not be, or to detect when an object is absent. The feedback from this sensor may be used by the controller 110 to issue processing interrupts or otherwise control operation of the printer 100. The other hardware 134 may also include a sensor to detect a flow rate or deposition rate of the build material.

The other hardware 134 may also or instead include a heating element (instead of or in addition to the thermal element 130) to heat the working volume such as a radiant heater or forced hot air heater to maintain the object 112 at a fixed, elevated temperature throughout a build, or the other hardware 134 may include a cooling element to cool the working volume.

A supply of build material 150 may provide the build material 150 in any suitable bulk form such as a filament on a spool for use by the printer 100. In general, the build material 150 may be a thermoalterable build material that can undergo an irreversible or non-reversing change in a material property that varies according to a maximum temperature reached by the build material 150. In general, a final property of the build material 150 in an object fabricated with the printer 100 is determined by the thermal energy applied to (or more accurately, actually transferred to) the build material during an extrusion process, e.g., during a melting, liquefaction, or the like. By controlling this heat transfer, it is possible to control the properties of the resulting object.

As used herein, the term thermoalterable build material is intended to refer to any material that exhibits an irreversible or non-reversing change in a property according to an amount of heat transferred to the material, such as during an extrusion process. One form of thermoalterable build materials, thermochromic build materials that change color, is described in commonly-owned U.S. patent application Ser. No. 13/478,233 filed on May 23, 2012 (hereinafter “the '233 patent application”), the entire content of which is hereby incorporated by reference.

While color is one property that might usefully be changed in a thermoalterable build material, a variety of other properties may also or instead be controlled. For example, this may include optical properties such as hue, saturation, and opacity. This may also include electrical properties such as conductivity, or conversely, resistivity. This may also include mechanical properties such as flexibility, elasticity, strength (e.g., tensile strength, sheer strength, and the like), viscoelasticity, stiffness, density, and so forth. In general, the thermoalterable build material may include any composition that exhibits a continuous, irreversible or non-reversing change in at least one such property in response to an applied thermal energy (e.g., heat). As used in the preceding sentence, “continuous” is intended to mean linearly related to the applied thermal energy in a predictable and controllable way over at least some range of applied energy. Thus while a material may remain unaltered and inelastic at some lower range of applied heats, and while the material may combust or vaporize at some higher range of applied heats, in some bounded range of applied heats therebetween, an irreversible change in a property may appear in proportion to the applied heat, which resulting property will be exhibited in the build material after returning to an ambient temperature such as room temperature.

An example of a commonly-known thermoalterable material that experiences a continuous, irreversible or non-reversing change in at least one property in response to an applied thermal energy (other than a color change, which is discussed elsewhere herein), is heat-shrink tubing. A common type of heat-shrink tubing experiences a continuous, irreversible change in density in response to an applied thermal energy. Specifically, when the heat-shrink tubing is heated to a certain temperature (the temperature being dependent on the type of material, and may include temperatures similar to that discussed with reference to three-dimensional printing), the density of the material increases as monomers contained therein become bonded together, therefore taking up less space. Accordingly, the material shrinks. The increased density (i.e., the irreversible change in a property) is exhibited in the heat-shrink tubing after returning to room temperature, and thus the heat-shrink tubing keeps its shrunken form.

In another aspect, the build material may usefully exhibit a reversible change in viscosity in response to the applied thermal energy in order to facilitate extrusion and subsequent cooling to form a solid object. This latter property is exhibited, for example, in a variety of thermoplastics and the like suitable for extrusion in a three-dimensional printing process, such as PLA, ABS, HDPL, and so forth. It will be understood that materials with this latter property may be mixed with thermoalterable materials to form a composite build material that is both suitable for extrusion and exhibits thermoalterability. For example, commercially available LAYWOO-D3 is formed of a thermoplastic and ground wood that becomes progressively darker as it is extruded at higher temperatures.

In one aspect, the build material 150 may be a thermochromic build material. A variety of techniques are known for temperature-based control of color, as described for example in the '233 patent application, any of which may be suitably adapted for use in a build material 150 as contemplated herein. For example, the build material 150 may include a polymer composition that irreversibly changes color in response to applied thermal energy. This may include a polymer combined with a thermochromic material that imparts a color that varies according to a temperature applied to the build material during an extrusion process.

The thermochromic material may be any additive that either independent from the polymer (or other matrix, binder, or the like for the thermochromic material) or in combination with the polymer yields a color to the composite material that can change color according to an applied temperature. It will be understood that the color change referred to herein may be a final color at ambient temperature after processing. That is, in order to achieve control over color in fabricated objects, the thermochromic additive may yield a controllable, irreversible change in color at ambient temperature so that objects with varying, controlled colors can be fabricated. Certain thermochromic materials may also or instead exhibit numerous color changes during a heating and liquefaction process, although such colors may not usefully result in a color-controlled object unless the changes are wholly or partially irreversible once ambient temperature is again attained. Thus, in one aspect, the build material 150 includes an irreversible thermochromic composition.

In one aspect, the thermochromic material may include an encapsulated dye that ruptures under applied temperature. In one aspect, such dyes may have a first color, and be encapsulated in an opaque capsule with a second color so that an aggregate transition from the second color (of the capsule) and the first color (of the dye) may be controlled via temperature during extrusion. In general, the capsules preferably rupture within a range of temperatures coincident with the melt temperature of the corresponding polymer or other material with which the thermochromic material is combined.

In another aspect, a material with inherent bulk thermochromic properties may be used as the thermochromic material. For example, polythiophenes result from polymerization of thiophenes, and exhibit various optical properties including various absorption and fluorescence spectra that result in, inter alia, temperature dependent color changes. Liquid crystals and leuco dyes are also known for use in a variety of thermally-dependent temperature changing applications.

More generally, a variety of thermochromic properties are known for a variety of materials, and any such material that exhibits a change in color due to a change in thermal energy, preferably an irreversible change in color due to a change in thermal energy, may be used as a thermochromic material as contemplated herein. Such color changes may result from changes to crystalline or other molecular structures that affect, e.g., Bragg diffraction, shifts in absorption spectrum, and so forth, or any other changes in light reflection, scattering, absorption, and the like that change as a molecular and/or crystalline structure changes with temperature. In addition, higher order structures in a bulk material may be achieved by an interaction of a polymer with an incorporated non-thermochromic additive that result in a thermochromic effect in a resulting composition. Similarly, a thermochromic additive may burn or char under temperature to achieve an irreversible color change or a general darkening or the like of the additive and the resulting composition.

A variety of commercially available irreversible thermochromic pigments, inks and dyes are also known for industrial applications such as time-temperature indications on packaging and the like. All such materials suitable for thermal control under conditions corresponding to operating parameters for a three-dimensional printer may be used as a thermochromic material as contemplated herein.

Other thermochromic materials are known in the art. For example, irreversible thermochromic behavior has been observed in gold and silver nanorod/polymeric ionic liquid nanocomposite films. Irreversible thermochromic behavior has also been observed in certain monoalcohol, diol, and monoester compounds of diacetylenes. Any such materials exhibiting thermochromic behavior in temperature ranges suitable for use in three-dimensional build materials may be adapted for use as contemplated herein.

While the '233 patent application describes control of a heater temperature as one technique for controlling the resulting property of a thermochromic build material in a fabricated object, it has more recently been observed that heat transfer to a build material may be indirectly controlled by controlling the rate at which the build material is passed through an extruder or similar device. Thus, by altering a flow rate of the thermoalterable build material 150 in a fabrication process, the desired control over final properties can be achieved. In one aspect, the controller 110 may control flow rate directly, e.g., by changing a speed of a filament drive. In another aspect, the controller 110 may control flow rate indirectly, e.g., by changing a speed of the x-y-z positioning assembly during extrusion in order to more rapidly draw material from the extruder in a thinner bead. In one aspect, by changing a speed of the x-y-z positioning assembly during extrusion, or by changing the flow rate directly, the extruder may spend more or less time in a certain portion of the build, which may trigger a desired property change. In one aspect, the final property of the thermoalterable build material 150 may depend on an amount of heat transfer to the build material 150 and in another aspect the final property may depend on a peak temperature of the build material 150. In either case, control may suitably be affected by the speed at which the build material 150 is drawn or driven through a heating system such as the extruder 106 and heater 126 contemplated herein.

Thus in general, the controller 110 may be programmed to heat a thermoalterable build material 150 to a first temperature suitable for extrusion (e.g., with the heater 126), and further programmed to operate the x-y-z positioning assembly 108 while extruding the thermoalterable build material 150 to fabricate the object 112. During this process, the controller 110 may alter a flow rate of the thermoalterable build material 150 through the extruder 106 to cause a change in heat transfer to the thermoalterable build material 150 so that a thermally controllable property of the thermoalterable build material can be controlled within the object 112. This process may be guided according to a map of variations in a property that spatially varies within the object, which may accompany a three-dimensional model and spatially identify locations and amounts of a desired property.

FIG. 2 shows a map of material properties for use in fabricating a three-dimensional object. In order to effectively control properties within a fabricated object, a map or other data structure may be stored in a memory, such as a memory of the three-dimensional printer or an associated computing device used to control fabrication of the object. Thus as shown in FIG. 2, a memory 200 may include a model 202 of an object and a map 204 of variations in at least one property that spatially varies within the object. In general, the model 202 may be any suitable digital model of a three-dimensional model such as a computer automated design (CAD) model, a stereolithography (STL) file, or any other representation of an object in three-dimensions. In another aspect, the model 202 may include tool instructions or the like that are directly executable by a three-dimensional printer, or any other suitable computerized representation of the object. A first representation 206 of the three-dimensional object depicted by the model 202, in this case a cylinder, is shown in the figure, along with a second representation 208 of the map, which will generally spatially correspond to the object and include an explicit identification of areas 210 where specific properties are desired. This may include surfaces of the object, voxels or other volumetric regions of the object, cross sections, ranges, or some combination of these. In one aspect, each area 210 may include a quantitative specification of a property, either as a physical value (e.g., a modulus of elasticity, or a specific color), or as a relative value (e.g., 0-100) over whatever available range is afforded by a particular thermoalterable build material.

The map, may, for example include a pattern of a particular structural property, or a color pattern for imparting a desired image or other visual effect on or in the object. In another aspect, the map may simply specify a predetermined variation in properties throughout the object using, e.g., a regular, recurring geometric pattern or the like that is readily amenable to algorithmic rather than spatial description.

FIG. 3 shows a cross-section of a composite thermoalterable build material. While a thermoalterable material may be mixed or otherwise distributed within a polymer build material, e.g., using the polymer as a matrix to structurally retain a thermoalterable material, a thermoalterable material may also or instead be disposed about an exterior of a polymer extrusion or the like to provide a temperature-sensitive composite. This fabrication technique advantageously permits the manufacture of a polymer filament with an elevated-temperature extrusion process and a subsequent, lower-temperature coating process for the thermoalterable build material, which prevents any preliminary, elevated-temperature manufacturing steps for the filament from imparting an irreversible color change to the thermoalterable material prior to use by a three-dimensional printer or the like.

In general, the thermoalterable build material 302 may include a core 304 of a polymer or any other suitable material, along with a sleeve 306 of thermoalterable material. The sleeve 306 may in general be any coating, sleeve, cladding, surface or the like that can be fabricated on an exterior of the core 304 using, e.g., a dipping process, deposition process, spray process, rolling process, cold extrusion process, as well as combinations of the foregoing and/or any other suitable technique(s).

In another aspect, this arrangement may be inverted, with a polymer exterior formed around or filled with a thermoalterable material. This approach may be appropriate where, for example, the thermoalterable material is highly malleable, or where the polymer can usefully provide thermal insulation to the thermoalterable material during extrusion.

FIG. 4 shows a method for three-dimensional printing using a thermoalterable build material.

As shown in step 402, the method 400 may include providing a model of an object and a map of variations in at least one property that spatially varies within the object. This may, for example, be any of the models or maps described above, all of which generally serve to define the object and a spatially varying property within the object in three dimensions.

As shown in step 404, the method 400 may include providing a supply of a thermoalterable build material. This may, for example, be any of the thermoalterable build material described herein. In one aspect, the thermoalterable build material may include a composition that exhibits a continuous, irreversible or non-reversing change in at least one property in response to an applied thermal energy. In another aspect, the thermoalterable build material may exhibit a reversible viscosity change in response to the applied thermal energy. As noted above, this contemplates a wide range of possible materials and mixtures of materials that might be used to fabricate an object while spatially controlling a property of the object through thermal control. The supply may be a filament on a spool, or any other suitable bulk supply.

As show in step 406, the method may include liquefying the thermoalterable build material at a predetermined temperature to obtain the reversible change in viscosity. This may be any temperature suitable for extruding the thermoalterable build material. While this contemplates a wide range of possible temperatures according to the composition of the material, certain polymers that may be used in thermoalterable compositions, such as ABS or PLA, can be extruded at temperatures of about two-hundred to about two-hundred thirty degrees Celsius.

More generally, liquefaction may include application of material viscosities over a range of temperatures according to a particular build material being used. It will also be understood that certain build materials may be liquid at an ambient temperature, or may only produce a limited liquefaction or flowability at extrusion temperatures. All such variations are intended to fall within the scope of liquefaction as used herein, and liquefaction may be omitted under certain conditions without departing from the scope of this disclosure, e.g., where a material is provided in an already liquid or flowable state.

It will also be appreciated that a desired property change need not occur at any particular moment during liquefaction, extrusion, and cooling. For example, a predetermined, irreversible color change may not manifest until after cooling of a thermochromic build material to an ambient temperature. In another aspect, the predetermined, irreversible property change may occur upon heating of the thermoalterable build material to a temperature such as the predetermined temperature for liquefaction. Given the variety of thermoalterable materials and combinations of thermoalterable materials known in the art, it should also be readily appreciated that a property change may exhibit some degree of hysteresis, e.g., so that the rate of temperature change, maximum temperature, and amount of time at one or more different temperatures may also affect a final property that is achieved when a thermoalterable build material returns to an ambient temperature. It should further be understood that a final property for a thermoalterable build material at ambient temperature may itself be variable. That is, the elasticity or conductivity may be temperature-dependent, varying with temperature changes around an ambient temperature. An average or temperature-specific value for the property may, or the resulting temperature dependence may for example be controlled by a highest temperature to which a material was heated or an amount of heat transfer to the material during an extrusion process. All such variations are intended to fall within the meaning of a thermoalterable material as that term is used herein unless a different meaning is explicitly provided or otherwise clear from the context.

By way of example, a material may become flowable at about 100 deg. C., at which temperature the material may be blue. At a temperature of 110 deg. C., the material may become blue-green. At a temperature of 120 deg. C., the material may become green. The final color for a fabricated object, or portion of an object, may be controlled by heating the material to the appropriate, corresponding temperature during extrusion. Where color adjustments are called for according to a map or model as described above, the temperature can be moved up or down within this range to move towards various colors.

As shown in step 408, the method 400 may include extruding the thermoalterable build material in a predetermined pattern according to the model. This may, for example, include depositing the thermoalterable build material within a working volume of a three-dimensional printer such as any of the printers described herein.

As shown in step 410, the method 400 may include varying a flow rate of the thermoalterable build material according to the map. As described above, this may control the thermoalterable property within the object to produce an object with variations in the thermoalterable property according to the map. Varying the flow rate, may for example, include varying a deposition rate of the thermoalterable build material during deposition, such as by adjusting an in-plane speed of the extruder while drawing a line of build material. This may also or instead include varying the extrusion rate of the thermoalterable build material, such as by varying a speed of a filament drive for the extrusion process.

As a significant advantage, the use of flow rate to control heat transfer and/or temperature of a thermoalterable material makes it possible to exercise instantaneous, localized control of the resulting properties within the object. Using such techniques, a variety of properties such as elasticity, conductivity, flexibility, tensile strength, density, plasticity, opacity, color, and the like may be controlled within an object, thus permitting fabrication of a wide range of functional and aesthetic devices. It will be further appreciated that certain materials or composites may exhibit a thermoalterable response of two or more properties, thus permitting a wide range of combinations of features. All such variations as would be apparent to one of ordinary skill in the art are intended to fall within the scope of this disclosure.

By way of example, a build material may be deposited at a first flow rate of 30.0 mm/s and be a first color (e.g., white or semi-transparent). When the flow rate is decreased to a second flow rate of 7.5 mm/s, the material may be deposited as a second color (e.g., black) because of the increased amount of heat energy transferred to the build material. In this scenario, varying the flow rate between 7.5 mm/s and 30.0 mm/s may yield a grayscale color, where the grayscale value (light or dark) is dependent upon the flow rate speed (e.g., closer to 30.0 mm/s yields a lighter grayscale while closer to 7.5 mm/s yields a darker grayscale).

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors, or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

It should further be appreciated that the methods above are provided by way of example. Absent an explicit indication to the contrary, the disclosed steps may be modified, supplemented, omitted, and/or re-ordered without departing from the scope of this disclosure.

The method steps of the invention(s) described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user or a remote processing resource (e.g., a server or cloud computer) to perform the step of X. Similarly, performing steps X, Y and Z may include any method of directing or controlling any combination of such other individuals or resources to perform steps X, Y and Z to obtain the benefit of such steps.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A three-dimensional printer comprising:
a memory storing a model of an object and a map of variations in at least one property that spatially varies within the object;
a supply of a thermoalterable build material including a composition that exhibits a continuous, irreversible or non-reversing change in the at least one property in response to an applied thermal energy and a reversible viscosity change in response to the applied thermal energy;
an x-y-z positioning assembly;
an extruder coupled to the x-y-z positioning assembly, the extruder including a heating element configured to heat the thermoalterable build material, thereby providing a heated build material; and
a controller coupled to the x-y-z positioning assembly and the extruder, the controller programmed to heat the thermoalterable build material with the heater to a first temperature suitable for extrusion, and further programmed to operate the x-y-z positioning assembly while extruding the thermoalterable build material to fabricate the object, wherein the controller alters a flow rate of the thermoalterable build material through the extruder to cause a change in heat transfer to the thermoalterable build material so that the at least one property of the thermoalterable build material is controlled within the object according to the map.

2. The three-dimensional printer of claim 1 wherein the supply of thermoalterable build material is formed into a filament.

3. The three-dimensional printer of claim 2 further comprising a filament drive coupled to the controller and configured to propel the filament through the extruder at a variable rate.

4. The three-dimensional printer of claim 3 wherein the controller alters the flow rate of the thermoalterable build material by changing a speed of the filament drive.

5. The three-dimensional printer of claim 1 wherein the controller alters the flow rate of the thermoalterable build material by changing a speed of the x-y-z positioning assembly.

6. The three-dimensional printer of claim 1 wherein the thermoalterable build material is a thermochromic build material.

7. The three-dimensional printer of claim 1 wherein the at least one property includes at least one of a hue, a saturation, and an opacity.

8. The three-dimensional printer of claim 1 wherein the at least one property includes a conductivity.

9. The three-dimensional printer of claim 1 wherein the at least one property includes a flexibility.

10. The three-dimensional printer of claim 1 wherein the at least one property includes a strength.

11. A method for three-dimensional printing comprising:
providing a model of an object and a map of variations in at least one property that spatially varies within the object;
providing a supply of a thermoalterable build material including a composition that exhibits a continuous, irreversible or non-reversing change in the at least one property in response to an applied thermal energy and a reversible viscosity change in response to the applied thermal energy;
liquefying the thermoalterable build material at a predetermined temperature to obtain the reversible change in viscosity;
extruding the thermoalterable build material in a predetermined pattern according to the model; and
varying a flow rate of the thermoalterable build material according to the map thereby producing the object with variations in the at least one property according to the map.

12. The method of claim 11 wherein extruding the thermoalterable build material includes depositing the thermoalterable build material within a working volume of a three-dimensional printer.

13. The method of claim 11 wherein varying the flow rate includes varying a deposition rate of the thermoalterable build material in the predetermined pattern.

14. The method of claim 11 wherein varying the flow rate includes varying an extrusion rate of the thermoalterable build material.

15. The method of claim 11 wherein the thermoalterable build material is a thermochromic build material.

16. The method of claim 11 wherein the at least one property includes at least one of a hue, a saturation, and an opacity.

17. The method of claim 11 wherein the at least one property includes a conductivity.

18. The method of claim 11 wherein the at least one property includes a flexibility.

19. The method of claim 11 wherein the thermoalterable build material includes a thermoalterable material mixed with a polymer.

20. The method of claim 11 wherein the map includes a color pattern for the object.

21. A computer program product for building an object from a supply of a thermoalterable build material including a composition that exhibits a continuous, irreversible or non-reversing change in at least one property in response to an applied thermal energy and a reversible viscosity change in response to the applied thermal energy, the computer program product comprising computer executable code embodied in a non-transitory computer readable medium that, when executing on a three-dimensional printer, performs the steps of:
receiving a model of an object and a map of variations in at least one property that spatially varies within the object;
liquefying the thermoalterable build material at a predetermined temperature to obtain the reversible change in viscosity;
extruding the thermoalterable build material in a predetermined pattern according to the model; and
varying a flow rate of the thermoalterable build material according to the map thereby producing the object with variations in the at least one property according to the map.
